(19) United States
(12) Patent Application Publication
(10) Pub. No.: US 2003/0021486 A1
(43) Pub. Date: Jan. 30, 2003

(54) Method and apparatus for image scaling

(76) Inventor: Tinku Acharya, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/917,476

(22) Filed: Jul. 27, 2001

(51) Int. Cl. G06K 9/46; G06K 9/36; G06K 9/32

(52) U.S. Cl. 382/250; 382/299

(57) ABSTRACT

Embodiments of an apparatus and method for up-scaling an image are described

### BACKGROUND

This disclosure is related to upscaling an image during decompression.

Up-sampling or up-scaling of images and/or video is an often employed operation in many image processing applications. Often, image and/or video data is down-sampled or down-scaled to reduce the resolution of the image frames. This allows it to be compressed to transmit it through a limited bandwidth communication channels or to accommodate limited storage space, as shown in FIG. 1, for example. However, it is also often desirable to display a higher resolution image or recover the original resolution of the image from the down-sampled compressed one. The brute-force method usually followed is to decompress the image first and then apply known up-scaling techniques on the decompressed image, as shown in FIG. 2. It would be desirable, however, if more efficient techniques to accomplish the same results with better or similar image quality were available.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram illustrating conventional down-scaling to reduce data;

FIG. 2 is a schematic diagram illustrating conventional up-scaling of an image after decompressing a smaller resolution image;

FIG. 3 is a schematic of one embodiment of a technique for up-scaling during decompression of a smaller resolution image;

FIG. 4 is a block diagram illustrating a conventional encoder and decoder, such as employed in connection with processing JPEG images;

FIG. 5 is a schematic diagram of the embodiment of FIG. 3 in greater detail; and

FIG. 6 is a table illustrating application of the embodiment of FIG. 5 to a particular example.

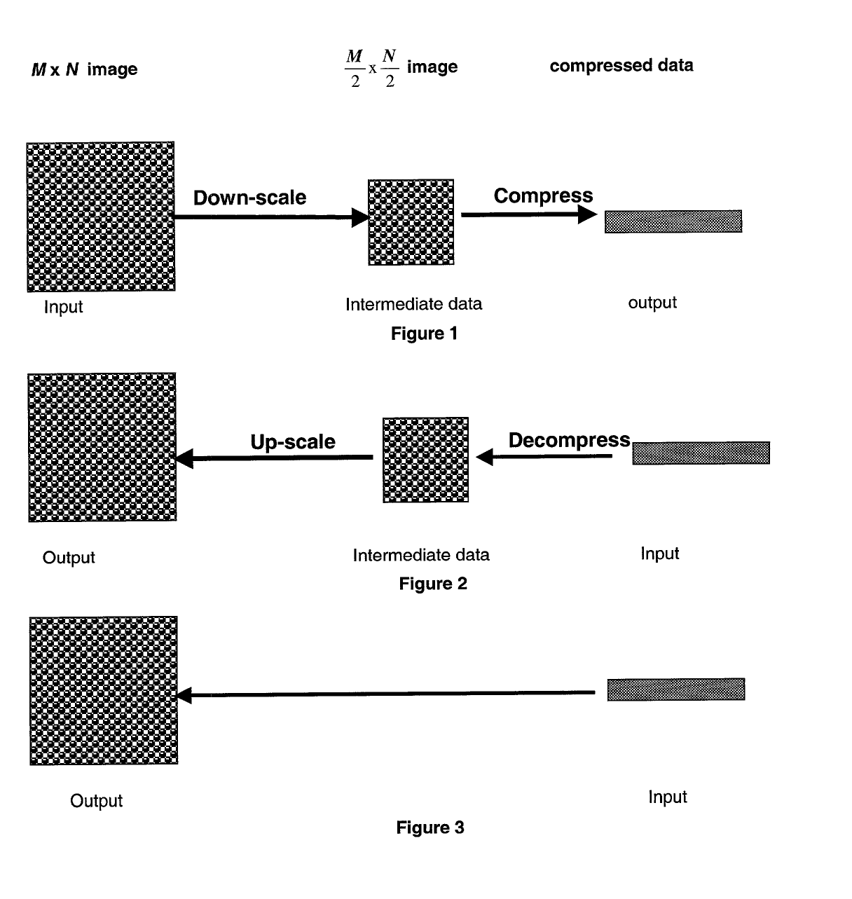

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

Briefly, embodiments are provided to permit an up-scaling operation to be achieved directly in the decompression process, as shown, for example, in FIG. 3. In such embodiments, the typical up-scaling employed to convert a lower resolution image to a higher one is embedded within the decompression that is performed. Although the claimed subject matter is not limited in scope in this respect, it is noted that this approach may be particularly suitable in Discrete Cosine Transform (DCT) based image compression/decompression systems or in situations that employ such techniques. Up-scaling may be achieved directly in the inverse DCT space as described, for example, in connection with the following embodiment.

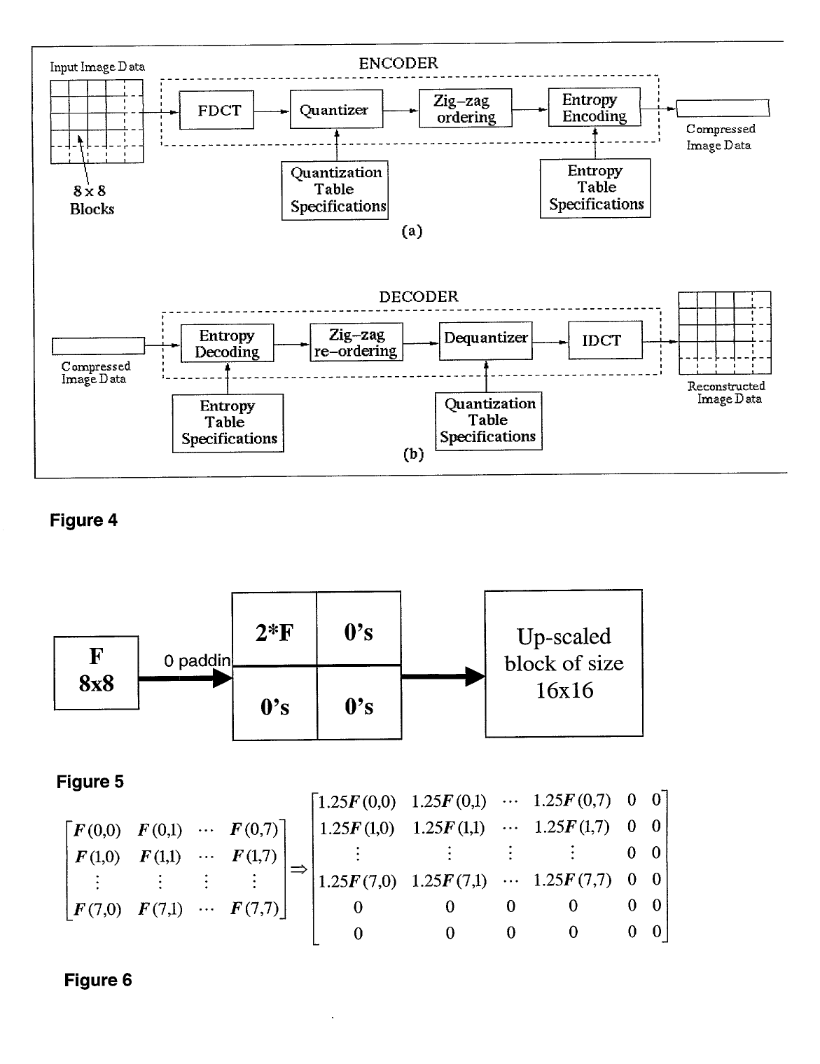

An up-sampling or up-scaling operation may be embedded into a decompression operation, such as, for example, a block based compression/decompression system using DCT. Although the claimed subject matter is not limited in scope in this respect, a baseline image compression standard, such as JPEG [Joint Photographic Experts Group, Digital Compression and Coding of Continuous-tone Still Images, ISO/IECJTC1/SC29 IS 10918] is one example. The process described in the JPEG specification follows the principles of block-based transform coding. A block diagram of this approach is shown schematically in FIG. 4.

As is well-known, the input image is divided into 8×8 blocks. The blocks are then independently compressed. First, the 8×8 block is converted from the spatial domain to the frequency domain by applying the Discrete Cosine Transform (DCT). The DCT coefficients are then quantized by dividing by a predefined quantization parameter. The quantized coefficients are then encoded to generate the compressed data as shown in FIG. 4(a).

For JPEG decompression, the inverse operations are applied. The compressed data is first entropy decoded to produce the quantized DCT coefficients. The quantized DCT coefficients are multiplied by the same or substantially the same quanitzation parameter that was used to quantize the original DCT coefficients during the compression process. This is called inverse-quantization and produces an approximation of the original DCT coefficients. The inverse quantized 8×8 DCT block is then converted into the spatial domain image data by applying an inverse Discrete Cosine Transform (IDCT). This is shown in FIG. 4(b).

The two-dimensional Discrete Cosine Transform (DCT) for a 8×8 block may be expressed mathematically as follows:

$$\begin{matrix}F ( u , v ) = \frac{C ( u ) C ( v )}{4} {\sum }_{x = 0}^{7} {\sum }_{y = 0}^{7} f ( x , y ) cos \frac{( 2 x + 1 ) u π}{16} \\ cos \frac{( 2 y + 1 ) v π}{16} where u , v = 0 , 1 … , 7 \\ C ( u ) = \{ \begin{matrix}\frac{1}{\sqrt{2}} & u = 0 \\ 1 & else\end{matrix}\end{matrix} \qquad ( 1 )$$

The corresponding two-dimensional inverse Discrete Cosine Transform (IDCT) of a 8×8 DCT block may, likewise, be expressed as follows:

$$\begin{matrix}f ( x , y ) = \frac{1}{4} {\sum }_{u = 0}^{7} {\sum }_{v = 0}^{7} C ( u ) C ( v ) F ( u , v ) cos \frac{( 2 x + 1 ) u π}{16} \\ cos \frac{( 2 y + 1 ) v π}{16} where x , y = 0 , 1 … , 7 \\ C ( u ) = \{ \begin{matrix}\frac{1}{\sqrt{2}} & u = 0 \\ 1 & else\end{matrix}\end{matrix} \qquad ( 2 )$$

Similarly, the two-dimensional inverse Discrete Cosine Transform (IDCT) of a 16×16 DCT block may be expressed as:

$$\begin{matrix}f ( x , y ) = \frac{1}{8} {\sum }_{u = 0}^{15} {\sum }_{v = 0}^{15} C ( u ) C ( v ) F ( u , v ) cos \frac{( 2 x + 1 ) u π}{32} \\ cos \frac{( 2 y + 1 ) v π}{32} where x , y = 0 , 1 … , 15 \\ C ( u ) = \{ \begin{matrix}\frac{1}{\sqrt{2}} & u = 0 \\ 1 & else\end{matrix}\end{matrix} \qquad ( 3 )$$

In general, an N×N point two-dimensional inverse DCT may be expressed as

$$\begin{matrix}f ( x , y ) = {\sum }_{u = 0}^{N - 1} {\sum }_{v = 0}^{N - 1} C ( u ) C ( v ) F ( u , v ) cos \frac{( 2 x + 1 ) u π}{2 N} \\ cos \frac{( 2 y + 1 ) v π}{2 N} where x , y = 0 , 1 … , N - 1 \\ C ( u ) = \{ \begin{matrix}\sqrt{\frac{1}{N}} & u = 0 \\ \sqrt{\frac{2}{N}} & else\end{matrix}\end{matrix} \qquad ( 4 )$$

Hence, an M×M point two-dimensional inverse DCT may be expressed as

$$\begin{matrix}{f}^{′} ( x , y ) = {\sum }_{u = 0}^{M - 1} {\sum }_{v = 0}^{M - 1} C ( u ) C ( v ) F ( u , v ) cos \frac{( 2 x + 1 ) u π}{2 M} \\ cos \frac{( 2 y + 1 ) v π}{2 M} where x , y = 0 , 1 … , M - 1 \\ {C}^{′} ( u ) = \{ \begin{matrix}\sqrt{\frac{1}{M}} & u = 0 \\ \sqrt{\frac{2}{M}} & else\end{matrix}\end{matrix} \qquad ( 5 )$$

Similarly, a 2N×2N point two-dimensional inverse DCT (IDCT) may be expressed as

$$\begin{matrix}{f}^{′} ( x , y ) = {\sum }_{u = 0}^{2 N - 1} {\sum }_{v = 0}^{2 N - 1} {C}^{′} ( u ) {C}^{′} ( v ) F ( u , v ) cos \frac{( 2 x + 1 ) u π}{2 * 2 N} \\ cos \frac{( 2 y + 1 ) v π}{2 * 2 N} where x , y = 0 , 1 … , 2 N - 1 \\ {C}^{′} ( u ) = \{ \begin{matrix}\sqrt{\frac{1}{2 N}} & u = 0 \\ \sqrt{\frac{1}{N}} & else\end{matrix}\end{matrix} \qquad ( 6 )$$

As shall be explained in more detail hereinafter, in embodiments in accordance with the claimed subject matter, an image may be up-scaled using the inverse-DCT (IDCT) operation during decoding. Let us assume, for example, that F(u, v) is an N×N block DCT block, where u=0,1, . . . , N−1 and v=0,1, . . . , N−1. Let us extend this 2-dimensional DCT signal F(u, v) of size N×N to another two-dimensional DCT signal F′(u,v) of size M×M (where M>N) by simply multiplying samples in F(u, v) by a scaling factor and padding F(u, v) with zeros to produce F′(u, v). Therefore, in this particular embodiment, F′(u, v)=k*F(u, v) for every u, v=0, 1, . . . , N−1 and F′(u, v)=0 for every u, v=N, N+1, . . . , M−1. This is depicted in the form of a matrix as shown in equation 7 below.

$$F ( 0 , ⋯ , N - 1 : 0 , ⋯ , N - 1 ) = ( \begin{matrix}F ( 0 , 0 ) & F ( 0 , 1 ) & ⋯ & F ( 0 , N - 1 ) \\ F ( 1 , 0 ) & F ( 1 , 1 ) & ⋯ & F ( 1 , N - 1 ) \\ ⋮ & ⋮ & ⋮ & ⋮ \\ F ( N - 1 , 0 ) & F ( N - 1 , 1 ) & ⋯ & F ( N - 1 , N - 1 )\end{matrix} ) \\ {F}^{′} ( 0 , ⋯ , M - 1 : 0 , ⋯ , M - 1 ) = ( \begin{matrix}kF ( 0 , 0 ) & kF ( 0 , 1 ) & ⋯ & kF ( 0 , N - 1 ) & 0 & 0 & ⋯ & 0 \\ kF ( 1 , 0 ) & kF ( 1 , 1 ) & ⋯ & kF ( 1 , N - 1 ) & 0 & 0 & ⋯ & 0 \\ ⋮ & ⋮ & ⋮ & ⋮ & ⋮ & ⋮ & ⋮ & ⋮ \\ kF ( N - 1 , 0 ) & kF ( N - 1 , 1 ) & ⋯ & kF ( N - 1 , N - 1 ) & 0 & 0 & & 0 \\ 0 & 0 & & 0 & 0 & 0 & & 0 \\ 0 & 0 & & 0 & 0 & 0 & & 0 \\ ⋮ & ⋮ & ⋮ & ⋮ & ⋮ & ⋮ & ⋮ & ⋮ \\ 0 & 0 & ⋯ & 0 & 0 & 0 & ⋯ & 0\end{matrix} ) \qquad ( 7 )$$

From Equations 4 and 5 above,

$$M * {C}^{′} ( u ) {C}^{′} ( v ) = N * C ( u ) C ( v ) or C ( u ) C ( v ) = \frac{M}{N} {C}^{′} ( u ) {C}^{′} ( v )$$

Hence, for convenience, we choose

$$k = \frac{M}{N}$$

the scaling factor. Similarly from Equations 4 and 6 above,

C(u)C(v)=2C′(u)C′(v)

Hence, for an 8×8 DCT block, as one example, although the claimed subject matter is not limited in scope in this respect, using the approach just described, we may expand the transformed signal by multiplying transformed coefficients by k=2 and then by zero padding, e.g., adding 8 extra rows and 8 extra columns of 0's to form a 16×16 block, in this example, as shown in FIG. 5, after inverse quantization, during a decompression operation. The extended 16×16 signal may then be inverse transformed to the image domain using a 16×16 inverse discrete cosine transform (IDCT), in this particular example. Again, the claimed subject matter is not limited in scope to these particular dimensions, of course. However, here, the resulting image is a 2:1 up-scaled image of the originally compressed image.

As the previous example illustrates, the change in standard JPEG decompression is to apply a 16×16 inverse-DCT on the 0 padded 16×16 block instead of an 8×8 inverse-DCT as the final operation in FIG. 4(b). In addition to having the advantage of producing the desired results, it is also relatively simple to implement in conjunction with existing image processing approaches, such as, for example, MPEG [Moving Picture Experts Group] family of video coding techniques MPEG-1 [Coding of Moving Pictures and Associated Audio for Digital Storage Media at up to about 1.5 Mbit/s, ISO/IEC IS 11172], MPEG-2 [Generic Coding of Moving Pictures and Associated Audio Information, ISO/IEC IS 13818], etc. and JPEG.

In embodiments in accordance with the claimed subject matter, therefore, without limitation, we may up-scale an image by k:1. For example, an image of size N×N may be up-scaled to size M×M where, M>N and M=k*N by, in this particular embodiment, multiplying the DCT coefficients by a scaling factor k=M/N and zero padding to convert, here, an 8×8 block, to an 8k×8k block. Again, for purposes of illustration, without intending any limitation on the claimed subject matter, to upscale an image by 1.25:1 (e.g., an 640×480 image may be up-scaled to 800×600), we may upscale 8×8 blocks to size 10×10. This may be done in this embodiment by multiplying the coefficients by k=1.25 and then zero padding the 8×8 block with two extra rows and two extra columns, as shown in FIG. 6 below. The 8k×8k block may then be inverse transformed by 8k×8k IDCT in order to produce the M×M image.

The embodiments previously described provide a variety of advantages. For example, as alluded to previously, the up-sampling method may be embedded into the decoding process and, hence, be transparent to the user. Memory utilization for an implementation of this approach is smaller compared to the traditional two-step approach, previously described, for up-scaling. Computational complexity and implementation complexity is improved relative to the traditional two step process of decompressing the image first followed by up-sampling. Furthermore, the embodiments previously described are suitable both for hardware and software implementation, and is suitable for on-line imaging applications, such as, video transmission, reprographics, scanning, and facsimiles, to provide just a few of the possible examples.

It will, of course, be understood that, although particular embodiments have just been described, the claimed subject matter is not limited in scope to a particular embodiment or implementation. For example, one embodiment may be in hardware, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or an imaging and/or video system, for example, may result in an embodiment of a method in accordance with the claimed subject matter being executed, such as an embodiment of a method of upscaling, for example, as previously described. For example, an image and/or video processing platform or system may include an image or video processing unit, a image or video input/output device and/or memory.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. A method of upscaling a decompressed image comprising:
multiplying frequency domain coefficients for the decompressed image by a scale factor to achieve a desired amount of image upscaling; and
padding the frequency domain coefficients with sufficient zeros to provide the desired scaling.

2. The method of claim 1, wherein the frequency domain coefficients comprise DCT transformed coefficients.

3. The method of claim 2, and further comprising:
inverse DCT transforming the scaled and padded DCT transformed coefficients for the decompressed image to provide a spatial domain image.

4. The method of claim 1, wherein the desired scaling comprises integer scaling.

5. The method of claim 1, and further comprising:
transforming the scaled and padded frequency domain coefficients for the decompressed image to provide a spatial domain image.

6. The method of claim 1, wherein the decompressed image was decompressed from a block based specification compliant compressed image.

7. The method of claim 6, wherein the block based specification compliant compressed image comprises at least one of a JPEG specification compliant compressed image and an MPEG specification compliant compressed image, where MPEG and JPEG, respectively, refer to a family of video coding specifications associated and the compressed image is compliant with at least one specification from one of the respective families of specifications.

8. An article comprising: a storage medium, said storage medium having stored thereon instructions, that, when executed result in upscaling a decompressed image by:
multiplying frequency domain coefficients for the decompressed image by a scale factor to achieve a desired amount of image upscaling; and
padding the frequency domain coefficients with sufficient zeros to provide the desired scaling.

9. The article of claim 8, wherein the frequency domain coefficients comprise DCT transformed coefficients.

10. The article of claim 9, wherein the instructions, when executed, further result in inverse DCT transforming the scaled and padded DCT transformed coefficients for the decompressed image to provide a spatial domain image.

11. The article of claim 9, wherein the desired scaling comprises integer scaling.

12. The article of claim 8, wherein the instructions, when executed, further result in transforming the scaled and padded frequency domain coefficients for the decompressed image to provide a spatial domain image.

13. The article of claim 9, wherein the decompressed image was decompressed from a block based specification compliant compressed image.

14. The article of claim 13, wherein the block based specification compliant compressed image comprises at least one of a JPEG specification compliant compressed image and an MPEG specification compliant compressed image, where MPEG and JPEG, respectively, refer to a family of video coding specifications associated and the compressed image is compliant with at least one specification from one of the respective families of specifications.

15. A system comprising:
a platform, said platform being adapted to up-scale decompressed images by multiplying frequency domain coefficients for the decompressed image by a scale factor to achieve a desired amount of image upscaling, and padding the frequency domain coefficients with sufficient zeros to provide the desired scaling.

16. The system of claim 15, wherein the frequency domain coefficients comprise DCT transformed coefficients.

17. The system of claim 16, wherein said platform is further adapted to inverse DCT transform the scaled and padded DCT transformed coefficients for the decompressed image to provide a spatial domain image.

18. The system of claim 15, wherein said platform is further adapted to inverse DCT transform the scaled and padded DCT transformed coefficients for the decompressed image to provide a spatial domain image.

19. The system of claim 15, wherein the system is futher adapted to decompress a block based specification compliant compressed image.

20. The system of claim 19, wherein the block based specification compliant compressed image comprises at least one of a JPEG specification compliant compressed image and an MPEG specification compliant compressed image, where MPEG and JPEG, respectively, refer to a family of video coding specifications associated and the compressed image is compliant with at least one specification from one of the respective families of specifications.
